(19) United States
(12) Patent Application Publication
(10) Pub. No.: US 2025/0194449 A1
(43) Pub. Date: Jun. 19, 2025

(54) SOIL-CULTIVATION DEVICE

(71) Applicant: LEMKEN GmbH & Co. KG, Alpen (DE)

(72) Inventors: Martin GEBBEKEN, Alpen (DE); Mark BERENDSEN, Lengel (NL)

(73) Assignee: LEMKEN GmbH & Co. KG, Alpen (DE)

(21) Appl. No.: 18/842,104

(22) PCT Filed: Feb. 28, 2023
(86) PCT No.: PCT/DE2023/100155

§ 371 Date: Aug. 28, 2024

(30) Foreign Application Priority Data
Mar. 2, 2022 (DE) 10 2022 104 961.2

(51) Int. Cl. A01B 29/04; A01B 29/06

(52) U.S. Cl. CPC A01B 29/041; A01B 29/06

(57) ABSTRACT

A roller for the agricultural soil cultivation has at least one support body that is rotatably mounted about an axis of rotation and multiple compaction rings arranged spaced apart from one another next to one another on the support body for compacting the ground and intermediate rings arranged between adjacent compaction rings. At least one first intermediate ring and a second intermediate ring with different diameters and/or different widths are provided. The roller includes at least one ring unit, which includes at least one compaction ring and at least one, in particular second, intermediate ring. The intermediate ring is connected to at least one adjacent compaction ring in a materially bonded manner or configured integrally with the compaction ring.

### CROSS-REFERENCE TO RELATED APPLICATION

This application is a national stage application, filed under 35 U.S.C. § 371, of International Patent Application PCT/DE2023/100155, filed on Feb. 28, 2023, which claims the benefit of German Patent Application DE 10 2022 104 961.2, filed on Mar. 2, 2022.

### TECHNICAL FIELD

The present disclosure relates to a soil cultivation implement in the form of a roller for an agricultural unit.

### BACKGROUND

In agriculture, rollers are usually employed for reconsolidating the soil following a preceding cultivation, wherein this can take place at different times or together combined with other soil cultivation implements. For cultivating the soil, the weight of the roller is utilized on the one hand while on the other hand a particular effect in the soil can also be achieved by a profiling of the lateral surface of the roller. Such a profiling can be achieved for example by constructing the roller out of individual discs or rings. When combined with other soil cultivation implements, for example a cultivating and sowing combination with seed coulters, a roller can be arranged for seedbed preparation directly in front of the seed coulters in order to bring about a pre-compaction of the soil. In addition to this, rollers can also be utilized for the depth guidance of a soil cultivation implement since they usually sink into the soil only slightly and substantially roll on the surface.

Such a ground roller is known from DE 195 17 184 A1, wherein the ground roller includes a support tube and compaction rings arranged, spaced apart, thereon. During the soil cultivation, soil can accumulate between the compaction rings as a result of which an optimal effect of the roller can be reduced. In addition, soil can be forced into the interior of the ground roller which can result in an accelerated corrosion and a diminished service life of the ground roller. At the back of the support tube, strippers are arranged below the axis of rotation of the ground roller, which engage between the compaction rings and contact the roller or at least reach up very closely to the roller. The strippers serve for removing soil adhesions which accumulate between the compaction rings during the work in the field, wherein the strippers and the soil adhesions can render a rolling of the ground roller more sluggish as a result of which pulling the roller can be difficult.

### SUMMARY

The present disclosure provides a roller for soil cultivation and an agricultural unit for soil cultivation which makes possible an improved or easier cultivation of the soil and has an improved service life. This is achieved through a roller as disclosed and claimed, and through an agricultural unit for soil cultivation as disclosed and claimed.

A roller for agricultural soil cultivation includes at least one support body that is rotatably mounted about an axis of rotation and multiple compaction rings arranged spaced apart next to one another on the support body for compacting the soil and intermediate rings arranged between adjacent compaction rings, wherein at least one first intermediate ring and one second intermediate ring with different diameters and/or different widths are provided. The roller comprises at least one ring unit which includes at least one compaction ring and at least one, in particular second, intermediate ring, wherein the intermediate ring is materially bonded to at least one adjacent compaction ring or formed integrally with the compaction ring.

The support body of the roller can be rotatably mounted about an axis of rotation on a support frame or directly on a main frame, for example of a cultivating and sowing combination. The compaction rings of the roller can be slid onto the support body in the axial direction along the axis of rotation. The compaction rings mounted onto the support body can be arranged on the support body side spaced apart from one another or in contact with one another. The compaction rings can be designed in the form of so-called trapezium rings for the row pre-compaction for seed coulters of cultivating and sowing combination. Between two adjacent compaction rings, at least one intermediate ring each can be arranged, wherein intermediate rings, based on the support body and/or the axis of rotation of the same, can have different widths in the axial direction and/or different diameters in the radial direction.

Intermediate rings with a smaller diameter can make possible a high and easy throughput of soil, but instead bring about less re-compaction and flattening of the ground. Intermediate rings with a larger diameter, which thus reach closer to the ground, can make possible a higher re-compaction and flattening of the ground, but have a lower and heavier throughput of soil because of their shorter distance to the ground radially outside. Through the arrangement of intermediate rings with different diameters and/or widths along the support body between the compaction rings, a roller can be advantageously adapted to different operating conditions and device combinations.

Thus, for example as row pre-compaction roller of a cultivating and sowing combination can be configured in such a manner that the same predominantly has a high, easy throughput of soil and, in the necessary regions, the required re-compaction and flattening of the ground.

At least one compaction ring is combined with an, in particular second, intermediate ring into a ring unit by means of a materially bonded connection or an integral configuration. Here, two compaction rings with an, in particular, second intermediate ring arranged in between, can be combined into a ring unit. Because of the materially bonded connection or integral configuration the ring unit offers the advantage that for example soil or water entering the substantially dust-proof and water-proof ring unit can be avoided, as a result of which corrosion can be avoided and the service life of the roller improved. Additionally, through the predominantly easy-to-pull configuration of the roller and the sufficient re-compaction and flattening of the ground, a cultivation of the soil can also be improved and facilitated.

In a preferred configuration, the roller comprises at least one first intermediate ring with a first diameter and a first width and at least one second intermediate ring with a second diameter and a second width, wherein the first diameter is smaller than the second diameter and/or the first width is smaller than the second width. The intermediate rings can be arranged coaxially to the compaction rings and/or the support body. In a mounted state, the first intermediate ring is arranged nearer to the support body than the second intermediate ring. This has the advantage that the first intermediate ring can make possible a higher throughput of soil than the second intermediate ring and pulling the roller can thus be easier. The second intermediate rings arranged in the radial direction further spaced apart from the support body offer the advantage of an improved re-compaction and flattening of the ground between the adjoining compaction rings, as a result of which for example an improved seedbed can be provided. The second intermediate rings can have a greater width than the first intermediate rings, as a result of which a larger region between compaction rings can be re-compacted and flattened. The first intermediate ring and the second intermediate ring can be produced from the same or from different material, for example plastic, metal and/or an elastic material. For example, a first intermediate ring, with lower load, can be produced from plastic and a second intermediate ring, because of the greater ground contact, of metal.

In a particularly preferred configuration, the, in particular, second intermediate ring circumferentially comprises a protective ring. The protective ring can be configured in the form of a ring arranged on the intermediate ring radially outside. Here, the protective ring can be materially bonded, positively and/or non-positively connected to the intermediate ring. The protective ring can have the same or slightly smaller width than the associated intermediate ring, wherein a slightly smaller width has the advantage that the intermediate ring arranged under the protective ring following an assembly remains peripherally accessible from the outside, for example, in order to establish a materially bonded connection with a compaction ring adjoining the intermediate ring. It is conceivable, further, that the protective ring is integrally produced with the intermediate ring, for example through a manufacturing process which allows processing of two different materials.

In a further configuration, the compaction rings and/or the intermediate rings each comprise an inner profile for the non-positive and/or positive connection to the support body. The support body can be configured in the form of a substantially cylindrical or profiled body such as a profile shaft. The compaction rings and/or intermediate rings can be slid onto the support body in the axial direction. Advantageous here is the simplified assembly of the compaction rings and/or intermediate rings on the support body and that the compaction rings and/or intermediate rings can be non-rotatably arranged on the support body, as a result of which the rotary motion of the same can take place more reliably and the functional safety of the roller can be increased. The inner profile of the compaction ring and/or of the intermediate ring can be formed continuously along the axis of rotation, as a result of which a large contact area for force transmission can be established and a force transmission to the support body for example can be improved.

In a particularly preferred configuration, the support body is designed in the form of a square tube and the inner profile in the form of a square profile matched to the form of the support body for the operative connection. This form of the support body and of the inner profile makes possible a simple non-rotatable mounting of the roller and a reliable operative connection between support body and ring unit, compaction ring and/or intermediate ring for force transmission. Besides the simplified assembly of the ring unit, of the compaction rings and/or intermediate rings on the support body, it is advantageous that the ring unit, compaction rings and/or intermediate rings can be non-rotatably arranged on the support body, as a result of which the rotary motion can take place more reliably and the functional safety of the roller can be increased.

In a particularly preferred configuration, the compaction ring is assembled from at least two half shells, in particular in a materially bonded manner. The half shells can each be plugged onto the support body in the axial direction. Prior to an assembly on the support body, the half shells can be connected to one another in a materially bonded manner to form a compaction ring. Through the, in particular, symmetrically configured half shells, a compaction ring can be cost-effectively produced and easily assembled.

In a further particularly preferred configuration, the compaction ring comprises at least on one side a substantially flat lateral surface for the materially bonded connection with an, in particular, second intermediate ring. The flat lateral surface has the advantage that intermediate rings of different diameters can be connected to the lateral surface in a materially bonded manner.

Preferentially, the ring unit, the compaction ring, the half shells and/or the intermediate ring are produced in the form of an injection molded part. The injection molding makes possible producing the ring unit, the compaction ring, the half shells and/or the intermediate ring as plastic part, which can be produced cost-effectively and additionally offers high corrosion resistance. It is also conceivable that an intermediate ring can be produced by extrusion as cost-effective extruded component, in particular from plastic.

Preferably, the ring unit, the compaction ring, the half shells and/or the intermediate ring comprise a rib structure and/or recesses formed on the inside. By forming recesses, the weight of the components can be reduced. The configuration of a rib structure in the interior of the ring unit, of the compaction ring, of the half shells and/or of the intermediate ring makes possible increasing their strength with reduced weight and an improvement of the force transmission.

In a preferred configuration the, in particular, second intermediate ring along its circumferential side comprises an outer profile which extends in particular radially to the outside from the circumferential surface. The outer profile can be designed in the form of webs, which are arranged on the circumferential side radially outside. The webs can be arranged at an angle or parallel to the axis of rotation. Through the outer profile a, for example, non-positive and/or positive connection of the intermediate ring to the protective ring can be improved. The outer profile can likewise comprise recesses directed radially to the inside, for example, for the positive connection to a protective ring which is correspondingly configured on the inside.

Preferentially, a materially bonded connection between the half shells and/or between the compaction ring and at least one intermediate ring is established through at least partial gluing and/or welding, in particular through laser beam welding or heated tool welding. The heated tool welding can take place in the form of mirror welding, as a result of which flat connections, for example of the lateral surface of the compaction ring to an intermediate ring can take place. Thus, for example two compaction rings can also be joined in a materially bonded manner with a, in particular second intermediate ring arranged in between to form a ring unit.

In a further preferred configuration, a clearer and/or a stripper are assigned to the first intermediate ring and/or the second intermediate ring respectively. The clearer and stripper can each be assigned to an intermediate ring and at least partially project into an intermediate space between adjacent compaction rings, in order to be able to remove soil adhesions from the respective intermediate space. The clearers and strippers can be arranged on the support frame. In the working direction, the support frame is arranged behind the axis of rotation of the roller as a result of which shorter and thus more stable clearers and/or strippers can be employed. In the case of the first intermediate ring with a smaller diameter, less soil adhesions than with the second intermediate ring with a larger diameter can occur so that in the case of a first intermediate ring a clearer for removing soil adhesions can be sufficient. The clearer projects partially between the adjacent compaction rings but is arranged spaced apart from the first intermediate ring, so that a low friction resistance occurs. A stripper, by contrast, can project further into the intermediate space between the compaction rings and contact the second intermediate ring circumferentially or reach up very closely to the same. Thus, the resistance during the operation can be greater than with the clearer. By using first and second intermediate rings with different diameters, the number of the required strippers can be reduced and thus the friction altogether reduced so that pulling the roller can be easier.

Preferentially, at least one bearing device is arranged on the support body end side, which has an adjustable axial preload force which makes possible applying a substantially axial force onto the ring unit, the compaction rings and/or intermediate rings. Through the bearing device, the support body with the ring unit, the compaction rings and/or intermediate rings can be rotatably mounted on the support frame. By applying an axial preload force, the stability and functional safety of the roller can be increased.

In a preferred configuration, the roller comprises multiple support bodies each mounted on a main frame, which are connected to one another in particular foldably. By arranging multiple support bodies, in particular via a support frame each, on the main body, the roller can be designed so as to be more compact, as a result of which a safe and regulation-compliant road transport can be made possible even with large working widths.

Furthermore, the disclosure relates to an agricultural unit for soil cultivation and/or application of granular solids in the form of fertilizer and/or seeds with at least one roller as described and designed above. The agricultural unit can be designed in the form of a cultivating and sowing combination which comprises for example a plurality of seed coulters, wherein each seed coulter can be assigned a compaction ring.

In a preferred configuration of the agricultural unit, the unit comprises in the working direction in front of the at least one roller a plurality of ground engagement means in the form of tires and/or tracks. In the working direction in front of the roller, the unit can comprise a chassis of multiple ground engagement means such as tires arranged next to one another, which substantially cover the working width of the unit and can carry the machine weight and re-compact and flatter the soil. Following the roller, in particular the compaction rings, the unit can each comprise seed coulters for sowing seeds into the ground behind the roller.

Because of the mounting of the ground engagement means, a distance or gap can each be formed between the ground engagement means. This gap can result in that during the soil cultivation between the ground engagement means the soil is re-compacted to a lesser degree and in each case a ridge of soil can develop. A second intermediate ring each can be assigned in the working direction to the gaps between two ground engagement means, while the remaining working region can be assigned first intermediate rings each. This has the advantage that through the second intermediate rings the region between the ground engagement means in each case can be re-compacted and flattened and the remaining regions comprise first intermediate rings, as a result of which an improved seedbed can be produced with a roller that is easier to pull.

In the following, the invention is explained in more detail by way of an exemplary embodiment.

### BRIEF DESCRIPTION OF THE DRAWINGS

FIG. 1 shows an agricultural unit in the form of a cultivating and sowing combination with a roller in a schematic plan view;

FIG. 2 shows a first intermediate ring, which is laterally arranged on a ring unit consisting of two compaction rings and a second intermediate ring arranged in between;

FIG. 3 shows a perspective view of the ring unit and of the first intermediate ring from FIG. 2;

FIG. 4 shows a perspective view of a second intermediate ring with a rib structure and recesses; and

FIG. 5 shows a perspective view of a half shell of a compaction ring.

### DETAILED DESCRIPTION

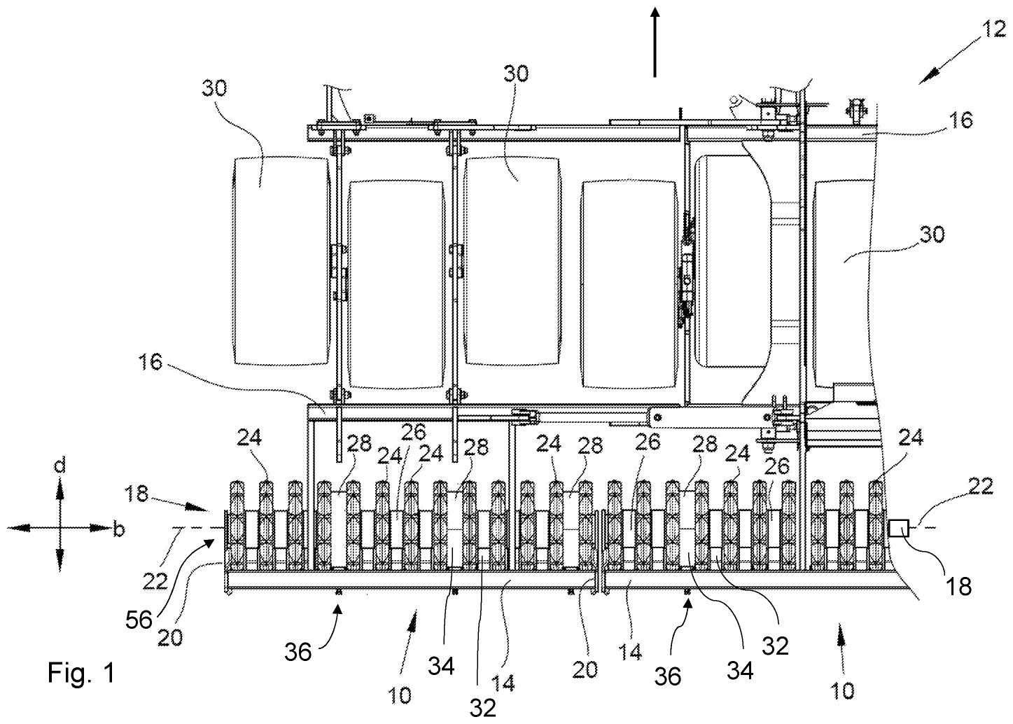

In FIG. 1, an agricultural unit 12 in the form of a cultivating and sowing combination is shown in a schematic view from above. The agricultural unit 12 comprises ground engagement means 30 in the form of tires arranged on a main frame 16, which are arranged next to one another and substantially cover the working width of the unit 12. The ground engagement means 30 can substantially carry the weight of the unit 12 and additionally serve for reconsolidating and flattening the soil for the subsequent seed application. For the preparation of the seed application by seed coulters (not shown), a roller 10 following the ground engagement means 30 in the working direction (arrow) is arranged, which likewise extends over the working width of the unit 12 and is arranged in the working direction in front of the seed coulters. The shown roller 10 is configured in multiple parts and comprises support frames 14, which are each attached to the main frame 16 and are designed so as to be foldable for example for road transport.

The roller 10 includes a plurality of compaction rings 24 which are arranged next to one another along a support body 18 on the same, wherein between the compaction rings 24 intermediate rings 26, 28 each are arranged. By way of a bearing device 56 arranged on the support body 18 end side, the compaction rings 24 and intermediate rings 26, 28 are preloaded in the axial direction. The support body 18 configured in the form of a square profile is rotatably mounted about an axis of rotation 22 and connected to the support frame 14 via webs 20. The compaction rings 24 are each arranged in front of a seed coulter (not shown) and serve for the row pre-compaction for the subsequent application of the crop through the seed coulters each in the pre-compacted rows. Because of the mounting of the ground engagement means 30 on the main frame 16, a gap each is formed between the ground engagement means 30 so that the ground between the ground engagement means 30 is re-compacted and flattened to a lesser degree and a ridge of soil can be created in each case.

The roller 10 comprises at least one first intermediate ring 26 and a second intermediate ring 28, which have different diameters d1, d2 and/or different widths b1, b2. The intermediate rings 26, 28 are configured in the form of a first intermediate ring 26 with a first diameter d1 and a first width b1 or of a second intermediate ring 28 with a second diameter d2 and a second width b2. The diameter d1 of the first intermediate ring 26 is smaller than the diameter d2 of the second intermediate ring 28. The first intermediate ring 26 makes possible an easy throughput of the soil between the adjoining compaction rings 24, whereas the second intermediate ring 28 has a lower throughput but instead makes possible a higher re-compaction and flattening of the ground. In the shown embodiment of the roller 10, each gap between two ground engagement means 30 is assigned a second intermediate ring 28 on the roller 10, which in the remaining working region a first intermediate ring 26 each is arranged between the compaction rings 24. Thus, the ground in the required places can be re-compacted and flattened by the second intermediate rings 28 for the seedbed preparation, wherein the roller 10, through the predominant number of first intermediate rings 26, substantially remains easy to pull.

The second intermediate rings 28 arranged between the compaction rings 24 are assigned a stripper 34 each, which substantially contacts the second intermediate element 28. The clearers 32 assigned to the first intermediate rings 26 engage less far into the respective space between the compaction rings 24. The clearers 32 and strippers 34 are each arranged on the support frame 14, which is arranged behind the axis of rotation 22 of the roller 10, as a result of which the clearers 32 and strippers 34 can be configured shorter and more rigidly.

The roller 10 comprises at least one ring unit 36, which includes at least one compaction ring 24 and at least one, in particular second, intermediate ring 26, 28, wherein the intermediate ring 26, 28 is connected to at least one adjacent compaction ring 24 in a materially bonded manner or configured integrally with the compaction ring 24. The ring units 36 shown in FIG. 1 each comprise two compaction rings 24 and a second intermediate ring 28 arranged in between and which is connected in a materially bonded manner to the compaction rings 24.

For removing adhering soil, two clearers 32 each are assigned to the first intermediate rings 26, which clearers are arranged spaced apart from the first intermediate rings 26 and cause only minor friction. The second intermediate rings 28 are each assigned strippers 34 which contact the second intermediate rings 28 or are arranged at least close up to these and cause a higher friction than the clearers 32. The number of the second intermediate rings 28 can depend on the number of the ground engagement means 30 and the gaps formed between these.

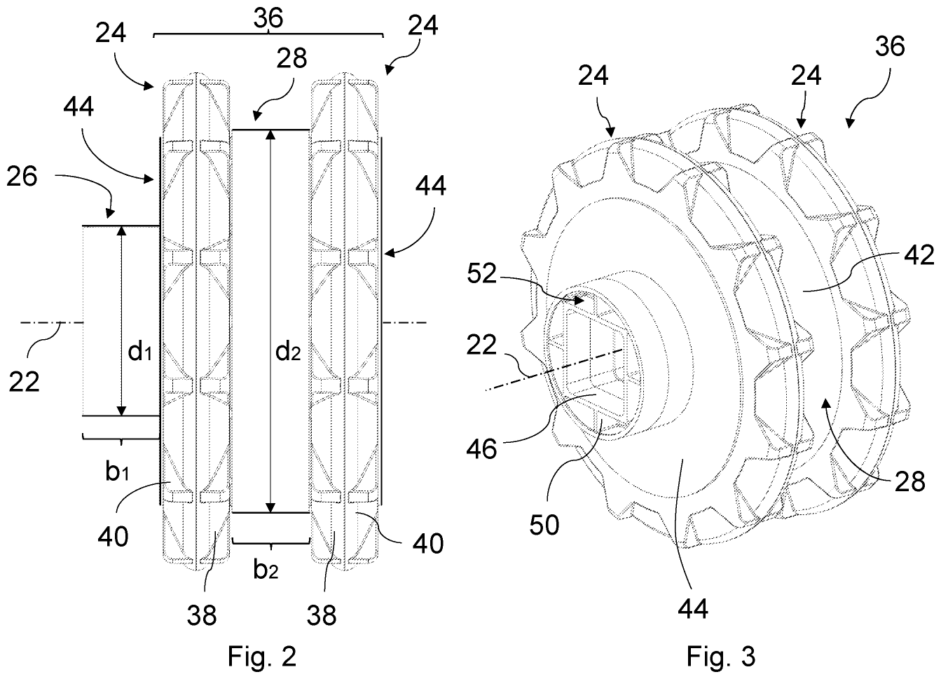

Seen in the working direction from the back, a ring unit 36 is shown in FIG. 2, which is arranged so as to be rotatable about the axis of rotation 22 on the support body (not shown). The shown ring unit 36 consists of two compaction rings 24 which are connected in a materially bonded manner to a second intermediate ring 28 on both sides. Radially outside, a protective ring 42 is arranged on the second intermediate ring 28. The protective ring 42 can be configured as metal ring and has a slightly smaller width than the second intermediate ring 28, so that between the protective ring 42 and the compaction rings 24 a gap each is formed. Despite protective ring 42, a materially bonded connection between the second intermediate ring 28 and the compaction rings 24 can be produced for example during the assembly for example by laser welding or mirror welding.

The compaction rings 24 are each assembled from a first half shell 38 and a second half shell 40. The half shells 38, 40 can be formed symmetrically and for the assembly be each slid onto the support body 18. Laterally, the compaction rings 24 each have a flat lateral surface 44, which can be connected to an intermediate ring 26, 28 in a materially bonded manner. Besides the ring unit 36, a first intermediate ring 26 is arranged on a side along the axis of rotation 22, wherein the first diameter d1 of the first intermediate ring 26 is smaller than the second diameter d2 of the second intermediate ring 26. The widths b1, b2 of the first and second intermediate ring 26, 28 are substantially equal in size.

FIG. 3 shows a perspective representation of the ring unit 36 from FIG. 2 and of the first intermediate ring 26 arranged thereon. Here, an inner profile 46 of the first intermediate ring 26 and of the left compaction ring 24 of the ring unit 36 are shown. The inner profile 46 is configured in the form of a square profile corresponding to the support body 18 (not shown). The support body (not shown) is configured in the form of a square shaft or a square profile, as a result of which a positive connection of the ring unit 36, of the compaction rings 24 and/or intermediate rings 26, 28 to the support body 18 is made possible. On the inside, the first intermediate ring 26 has a rib structure 50 and recesses 52, as a result of which a strength between the intermediate ring 26 with simultaneous weight reduction can be increased.

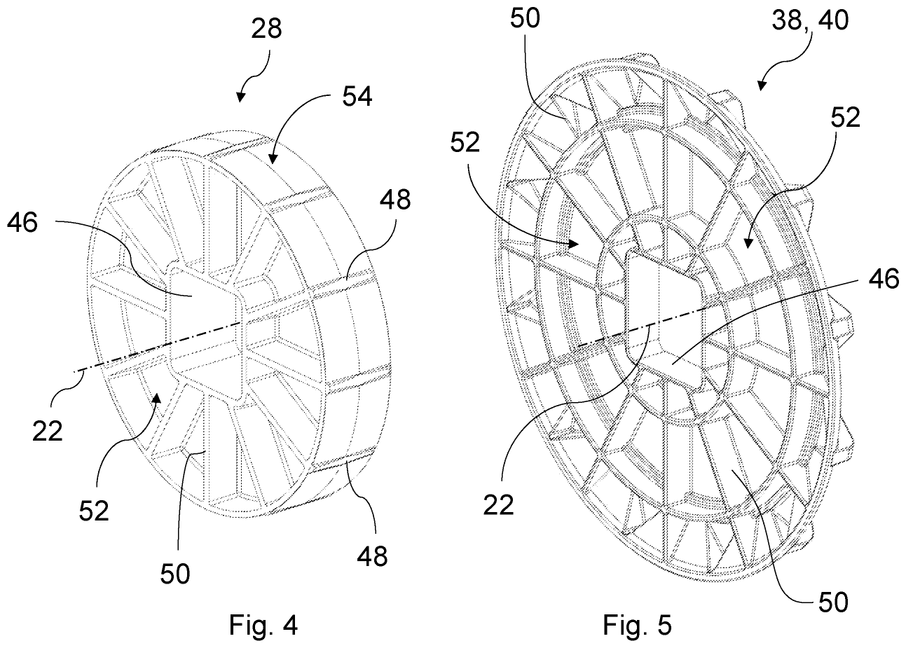

The second intermediate ring 28 shown in the FIG. 4 likewise comprises a rib structure 50 and recesses 52 on the inside. The inner profile 46 of the second intermediate ring 28 is configured corresponding to the support body (not shown) in the form of a square profile in order to make possible a positive connection to the support body. Radially outside, the second intermediate ring 28 has a circumferential surface 54. On the circumferential surface 54, an outer profile 48 is formed which is configured in the form of webs rising radially to the outside. Through the outer profile 48, a for example non-positive, positive and/or materially bonded connection to the protective ring (not shown) can be improved.

A half shell 38, 40 of a compaction ring 24 is shown in a perspective view in FIG. 5. On the inside, the half shell 38, 40 comprises a rib structure 50 and recesses 52. For the positive connection to the support body (not shown), the half shell 38, 40 additionally has an inner profile 46 in the form of a square profile. The half shells 38, 40 are formed symmetrically and can, in particular prior to an assembly of the support body or prior to an assembly into a ring unit, be connected to one another in a materially bonded manner. The ring unit 36, the half shells 38, 40, the compaction rings 24 and/or the intermediate rings 26, 28 can be produced as plastic parts in particular as injection molded parts. This offers the advantage that a rib structure 50 and recesses 52 can be cost-effectively produced.

### LIST OF REFERENCE NUMBERS

10 Roller
12 Agricultural unit
14 Support frame
16 Main frame
18 Support body
20 Web
22 Axis of rotation
24 Compaction ring
26 First intermediate ring
28 Second intermediate ring
30 Ground engagement means
32 Clearer
34 Stripper
36 Ring unit
38 First half shell
40 Second half shell
42 Protective ring
44 Lateral surface
46 Inner profile
48 Outer profile
50 Rib structure
52 Recesses
54 Circumferential surface
56 Bearing device
d1 First diameter
d2 Second diameter
b1 First width
b2 Second width

1.-16. (canceled)

17. A roller (10) for agricultural soil cultivation, comprising:
a support body (18) rotatably mounted about an axis of rotation (22);
compaction rings (24) arranged side by side and spaced apart from one another on the support body (18) for compacting a ground; and
intermediate rings (26, 28) arranged between adjacent compaction rings (24), including at least one first intermediate ring (26) and at least one second intermediate ring (28) with different diameters (d1, d2) and/or different widths (b1, b2),
wherein at least one of the compaction rings (24) and at least one of the intermediate rings (26, 28) form a ring unit (36), and
wherein the at least one of the intermediate rings (26, 28) is connected to the at least one of the compaction rings (24) in a materially bonded manner or integrally formed with the one of the compaction rings (24).

18. The roller according to claim 17,
wherein the at least one first intermediate ring (26) has a first diameter (d1) and a first width (b1) and the at least one second intermediate ring (28) has a second diameter (d2) and a second width (b2),
wherein the first diameter (d1) is smaller than the second diameter (d2) and/or the first width (b1) is smaller than the second width (b2).

19. The roller according to claim 18,
wherein the at least one second intermediate ring (28) circumferentially comprises a protective ring (42).

20. The roller according to claim 17,
wherein the compaction rings (24) and/or the intermediate rings (26, 28) each have an inner profile (46) for positive connection to the support body (18).

21. The roller according to claim 20,
wherein the support body (18) is a square tube and
wherein the inner profile (46) is a square profile matched to the support body (18) for an operative connection.

22. The roller according to claim 17,
wherein the compaction rings (24) are assembled from at least two half shells (38, 40) in a materially bonded manner.

23. The roller according to claim 17,
wherein the at least one of the compaction rings (24) has a substantially flat lateral surface (44) on one side for a materially bonded connection to the at least one of the intermediate rings (26, 28).

24. The roller according to claim 17,
wherein the ring unit (36) is an injection molded part.

25. The roller according to claim 17,
wherein the ring unit (36) has a rib structure (50) and/or recesses (52) formed on an inside thereof.

26. The roller according to claim 17,
wherein the at least one of the intermediate rings (26, 28) has an outer profile (48) along its circumferential side, which extends from a circumferential surface radially outside.

27. The roller according to claim 22,
wherein the at least one of the intermediate rings (26, 28) is connected to the at least one of the compaction rings (24) in the materially bonded manner by gluing or welding.

28. The roller according to claim 17,
wherein the at least one first intermediate ring (26) is assigned a clearer (32) and/or
wherein the at least one second intermediate ring (28) is assigned a stripper (34).

29. The roller according to claim 17,
wherein at least one bearing device (56) is arranged on the support body (18) end side,
wherein the at least one bearing device (56) comprises an adjustable axial preload force which makes possible applying an axial force onto the ring unit (36), the compaction rings (24), and/or the intermediate rings (26, 28).

30. The roller according to claim 17,
wherein the support body (18) is one of multiple support bodies (18) each mounted on a main frame (16), and
wherein the multiple support bodies (18) are connected to one another so as to be foldable.

31. An agricultural unit (12) for soil cultivation and/or application of granular solids in form of fertilizer and/or seeds having at least one roller (10) according to claim 17.

32. The agricultural unit according to claim 31,
wherein the agricultural unit (12) in a working direction in front of the at least one roller (10) comprises a plurality of ground engagement means (30) in form of tires and/or tracks.
